(19) United States
(12) Patent Application Publication
(10) Pub. No.: US 2012/0091117 A1
(43) Pub. Date: Apr. 19, 2012

(54) ELECTRIC KETTLE OF TEMPERATURE WIRELESS TRANSMISSION

(75) Inventor: Shengfang Cheng, Taiwan (CN)

(73) Assignee: TSANN KUEN (ZHANGZHOU) ENTERPRISE CO., LTD., Fujian (CN)

(21) Appl. No.: 13/266,571

(22) PCT Filed: Mar. 9, 2010
(86) PCT No.: PCT/CN10/70934

§ 371 Date: Oct. 27, 2011

(30) Foreign Application Priority Data
Apr. 28, 2009 (CN) 200920138125.5

(51) Int. Cl. H05B 1/00; H05B 3/02

(52) U.S. Cl. 219/385

(57) ABSTRACT

An electric kettle of temperature wireless transmission includes a body and a base. The base is disposed with a first power substrate, a relay, a first wireless IC module and a wireless receiver. The body is disposed with a second power substrate, a second wireless IC module, a wireless transmitter, a pipe heater and a thermistor. The body and the base of the kettle is disposed with wireless transmitter and wireless receiver separately, the wireless transmitter transmits the water temperature sensed from the thermistor in the body to the first power substrate in the base, the temperature is controlled by the first power substrate and the relay, the signal transmission is still taken place after the body is disconnected from the base.

### FIELD OF THE INVENTION

The present invention relates to an electric kettle, especially to an electric kettle of temperature wireless transmission.

### BACKGROUND OF THE INVENTION

There are two kinds of signal transmission manner from the temperature sensor to the temperature control device in the electric kettle: one is electrical connection directly, the other one is photoelectric transmission. In the first manner, the body of the kettle and the base cannot be disconnected during the temperature signal transmission, and the temperature cannot be displayed. In the second manner, as the transmission and the receiving angle problem is taken place when the photoelectric transmission element is disposed in the bas, the body cannot receive signal and the temperature cannot be displayed when the base is disconnected. The liquid temperature cannot be read after the body is disconnected from the base, making the usage inconvenient.

### SUMMARY OF THE INVENTION

The object of the present invention is to provide with an electric kettle of temperature wireless transmission, which overcomes the existing kettle of unable to display and control the temperature after the body is disconnected from the base.

The technical proposal of the present invention is:

An electric kettle of temperature wireless transmission, including a body and a base, the base is disposed with a first power substrate, relay, a first wireless IC module and a wireless receiver, the first power substrate electric connects to the first wireless IC module, the first wireless IC module electric connects to the wireless receiver; the body is disposed with a second power substrate, a second wireless IC module, a wireless transmitter, pipe heater and thermistor, the second power substrate electric connects to the second wireless IC module, the thermistor electric connects to the second wireless IC module, the second wireless IC module electric connects to the wireless transmitter;

The firs power substrate electric connects to the second power substrate by the bottom of the body and the seated connection disposed in the upper portion of the base, the relay electric connects to the pipe heater, the wireless receiver connects to the wireless transmitter by the radio signal;

A temperature display is disposed in the body or the base.

Another preferred embodiment, a back-up power is disposed in the body, the back-up power electric connects to the second wireless IC module to supply power to the body when the body disconnect from the base.

Another preferred embodiment, the temperature display is the first temperature display disposed in the base, the first temperature display electric connects to the first wireless IC module.

Another preferred embodiment, the temperature display is the second temperature display disposed in the body, the second temperature display electric connects to the second wireless IC module.

Another preferred embodiment, a second temperature display is disposed in the body; the second temperature display electric connects to the second wireless IC module.

Another preferred embodiment, a handle is disposed in the body, the wireless transmitter is disposed in the handle.

Another preferred embodiment, the first wireless IC module and the second wireless IC module are infrared IC module, the wireless receiver is infrared receiver and the wireless transmitter is infrared transmitter.

Another preferred embodiment, the kettle further includes a probe-type liquid temperature sensor, which is disposed with IC module, thermistor, temperature display and power.

Compared to the existing technology, the present invention of an electric kettle of temperature wireless transmission has the advantages below:
1. The body and the base are disposed with wireless transmitter and wireless receiver separately, the wireless transmitter transmits the temperature signal sensed from the thermistor in the body to the first power substrate of the base, the first power substrate and the relay will control the temperature, so the signal transmission happens after the body is disconnected from the base.
2. The body is disposed with back-up power, which will be started up to supply power to the second wireless IC module, the wireless transmitter and the thermistor to sense the water temperature and transmit the is temperature signal after the body is disconnected from the base.
3. There is temperature display disposed in the body and the base, so the user can read the temperature in the body directly. When the body is disconnected from the base, the temperature display still works with the back-up power in the body after the power is cut off.
4. The present invention includes a probe-type liquid temperature sensor, which can sense the water temperature in the kettle at any time, convenient for the user to choose.
5. The wireless transmitter is disposed in the handle, which makes the wireless transmitter far away from the pipe heater or other heating element. So the wireless transmission and the quantity of the receiving will not be affected due to the high temperature, which reduces the wrong action and increases the service life of the wireless transmitter.

### BRIEF DESCRIPTION OF THE DRAWINGS

FIG. 1 illustrates the section-cross structure of the first preferred embodiment;

FIG. 2 illustrates the circuit arrangement of the first preferred embodiment;

FIG. 3 illustrates the circuit arrangement of the second preferred embodiment;

FIG. 4 illustrates the circuit arrangement of the third preferred embodiment;

FIG. 5 illustrates the circuit arrangement of the fourth preferred embodiment;

FIG. 6 illustrates the circuit arrangement of probe-type liquid temperature sensor in the forth preferred embodiment.

### DETAILED DESCRIPTION OF THE PREFERRED EMBODIMENT

The present invention is further described from the preferred embodiments below.

The first preferred embodiment:

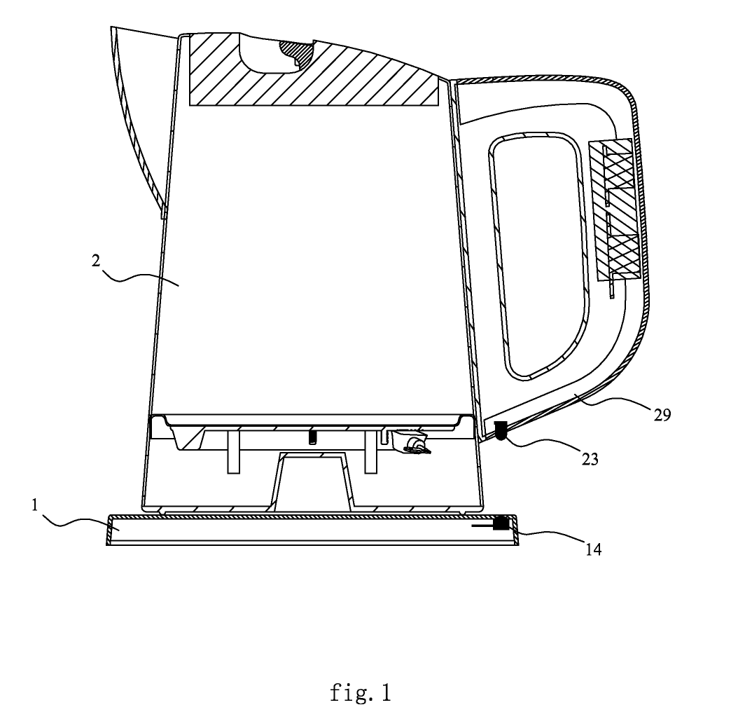

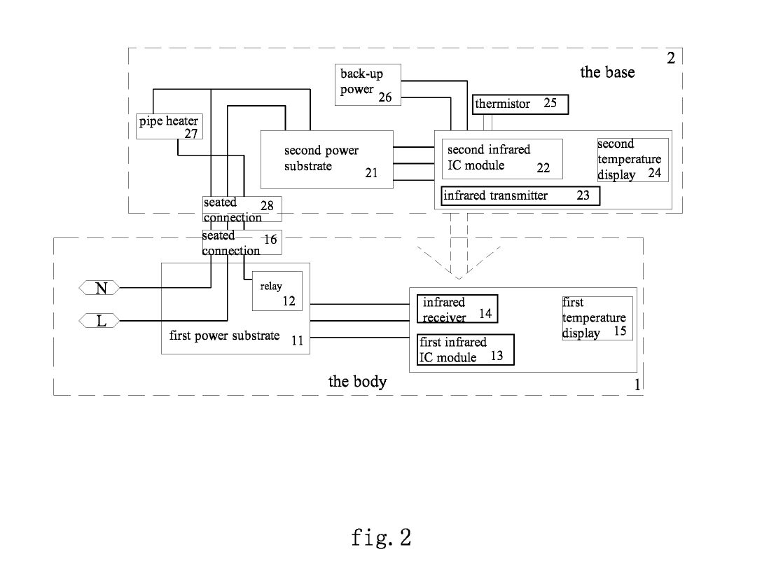

Refer to the FIG. 1 and FIG. 2, the present invention of an electric kettle of temperature wireless transmission includes a body 2 and abase 1. the base is disposed with a first power substrate 11, a relay 12, a first infrared IC module 13, an infrared receiver 14, a first temperature display 15 and a seated connection 16, the first power substrate 11 electric connects to the relay 12, the first infrared IC module 13 and the seated connection 16 separately, the first infrared IC module 13 electric connects to the infrared receiver 14 and the first temperature display 15 separately. The body 2 is disposed with a second power substrate 21, a second infrared IC module 22, an infrared transmitter 23, a second temperature display 24, a thermistor 25, a back-up power 26, a pipe heater 27 and a seated connection 28, the body 2 is further disposed with a handle 29, the infrared transmitter is disposed in the handle 29. the second power substrate 21 electric connects to the second infrared IC module 22, the pipe heater 27, the seated connection 28 separately, the second infrared IC module 22 electric connects to the infrared transmitter 23, the second temperature display 24, the thermistor 25 and the back-up power 26 separately.

When in use, the body 2 connects to the base 1, the first power substrate 11 of the base 1 is powered. The temperature of the water to heat is set after the first power substrate 11 works. Then the relay 12 controls the pipe heater 27 by the seated connection 16 and the seated connection 28. When the base 1 and the base 2 is connected together, the second power substrate 21 of the body 2 is powered. The second infrared IC module 22 real-time senses the water temperature by the thermistor 25 after the second power substrate 21 is powered, the sensed temperature signal will be displayed in the second temperature display 24. At the same time, the infrared transmitter 23 transmits the temperature signal to the infrared receiver 14, which feedbacks the temperature signal to the first infrared IC module 13. The first infrared IC module 13 displays the temperature signal transformed from the infrared signal on the first temperature display 15 of the base 1. If the water temperature in the body 2 reaches the set value, the first power substrate 11 controls the water temperature in the body 2 by controlling the on-off of the heating is circuit.

The present invention displays the temperature on the first temperature display 15 and the second temperature display 24 at the same time, making the user read the water temperature in the body 2 directly. The back-up power 26 is started up to supply power to the second infrared IC module 22, the infrared transmitter 23, the second temperature display 24 and the thermistor 25 after the body 2 is disconnected from the base 1, so the water temperature is enable to sensed, and the temperature signal is enable to transmit, ensuring that the temperature display of the first temperature display 15 and the second temperature display 24 is enable after the second power substrate 21 is powered off.

The second preferred embodiment:

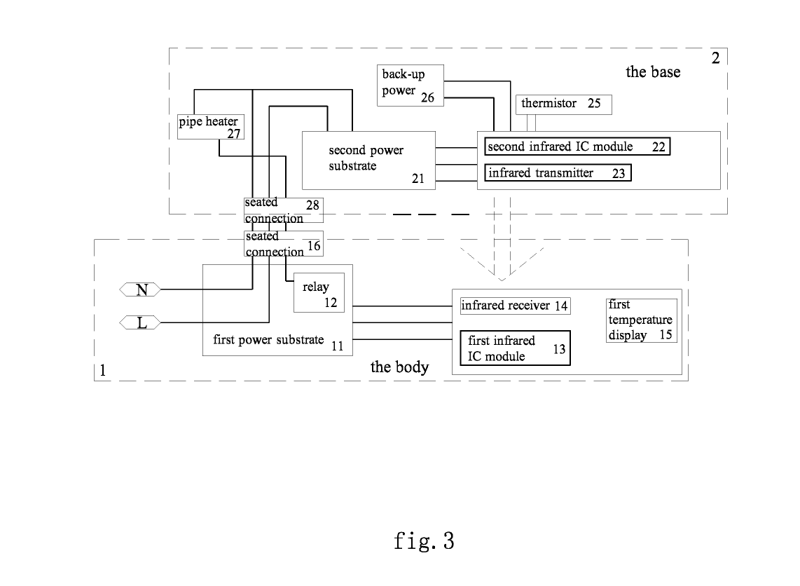

Refer to the FIG. 3, an electric kettle of temperature wireless transmission in the present invention is provided. The principle is basically the same with the first preferred embodiment. The difference is:

This preferred embodiment is provided without the second temperature display. The second infrared IC module real-time senses the water temperature by the thermistor 25 after the second power substrate 21 is powered. The infrared transmitter 23 transmits the present temperature signal to the infrared receiver 14 in the base 1 directly. The infrared signal is feedback to the first infrared IC module 13 by the infrared receiver 14. Then the first infrared IC module 13 displays the temperature signal transformed from the infrared signal on the first temperature display 15. The back-up power 26 is started up to ensure the first temperature display 15 is enable to display after the second power substrate 21 is powered off.

The third preferred embodiment:

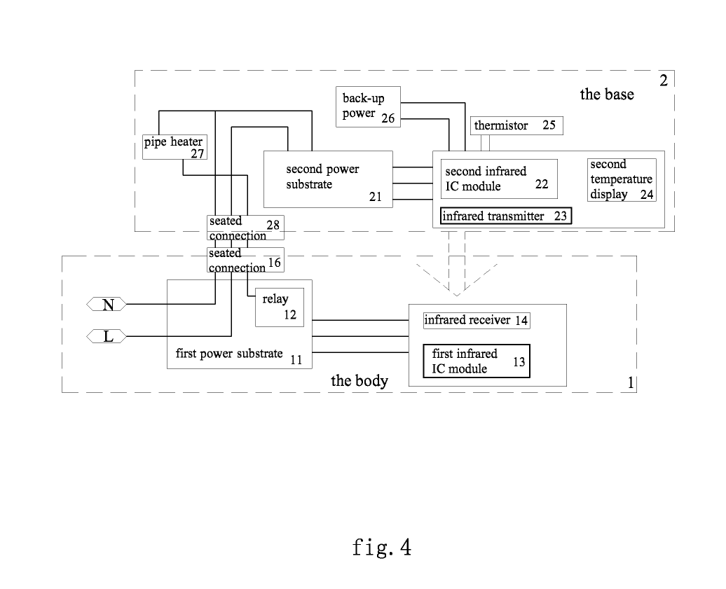

Refer to the FIG. 4, an electric kettle of temperature wireless transmission in the present invention is provided. The principle is basically the same with the first preferred embodiment. The difference is:

This preferred embodiment is provided without the first temperature display. The second infrared IC module real-time senses the water temperature by the thermistor 25 after the second power substrate 21 is powered. The infrared transmitter 23 transmits the present temperature signal to the infrared receiver 14 in the base 1 directly. The infrared signal is feedback to the first infrared IC module 13 by the infrared receiver 14. When the water temperature of the body 2 reaches to the set value, the first power substrate 11 controls the water temperature in the body 2 by controlling the on-off of the heating circuit.

The fourth preferred embodiment:

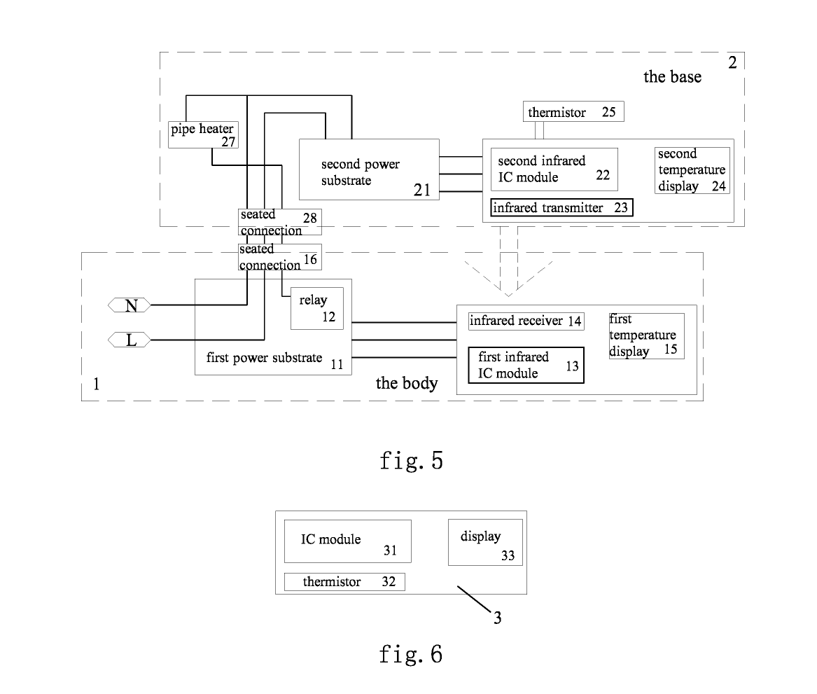

Refer to the FIG. 5, an electric kettle of temperature wireless transmission in the present invention is provided. The principle is basically the same with the first preferred embodiment. The difference is:

This preferred embodiment is provided without back-up power 26, but disposed with a probe-type liquid temperature sensor, which is disposed independently from the body 2 and the base 1. The probe-type liquid temperature sensor includes an IC module 31, a thermistor 32, a display 33 and a power. The power applies a battery or the mains supply. The probe-type liquid temperature sensor is enable to sense the water temperature in the body 2 after the body 2 is disconnected to the base 1. The user can real-time read and control the temperature.

Although the present invention has been described with reference to the preferred embodiments thereof for carrying out the invention, the technical proposal of the present invention is not limited. For example, firstly, the temperature wireless transmission applies the infrared transmission, but not excluding other wireless transmission manner; secondly, the circuit arranged in the base and the body can be changed over, that is controlling part disposed in the handle and the display disposed in the base, satisfying different kettle structure. It is apparent to those skilled in the art that a variety of modifications and changes may be made without departing from the scope of the present invention which is intended to be defined by the appended claims.

### INDUSTRIAL APPLICABILITY

The present invention provides with an electric kettle, the body and the base of the present invention is disposed with wireless transmitter and wireless receiver separately, the wireless transmitter transmits the water temperature sensed from the thermistor in the body to the first power substrate in the base, the temperature is controlled by the first power substrate and the relay, the signal transmission is still taken place after the body is disconnected from the base. The present invention is easy used and simple structure with well industrial applicability.

1. An electric kettle of temperature wireless transmission, including a body and a base, wherein:
The base is disposed with a first power substrate, relay, a first wireless IC module and a wireless receiver, the first power substrate electric connects to the first wireless IC module, the first wireless IC module electric connects to the wireless receiver; the body is disposed with a second power substrate, a second wireless IC module, a wireless transmitter, pipe heater and thermistor, the second power substrate electric connects to the second wireless IC module, the thermistor electric connects to the second wireless IC module, the second wireless IC module electric connects to the wireless transmitter;
The firs power substrate electric connects to the second power substrate by the bottom of the body and the seated connection disposed in the upper portion of the base, the relay electric connects to the pipe heater, the wireless receiver connects to the wireless transmitter by the radio signal;
A temperature display is disposed in the body or the base.

2. An electric kettle of temperature wireless transmission according to the claim 1, wherein a back-up power is disposed in the body, the back-up power electric connects to the second wireless IC module to supply power to the body when the body disconnect from the base.

3. An electric kettle of temperature wireless transmission according to the claim 1, wherein the temperature display is the first temperature display disposed in the base, the first temperature display electric connects to the first wireless IC module.

4. An electric kettle of temperature wireless transmission according to the claim 1, wherein the temperature display is the second temperature display disposed in the body, the second temperature display electric connects to the second wireless IC module.

5. An electric kettle of temperature wireless transmission according to the claim 3, wherein a second temperature display is disposed in the body, the second temperature display electric connects to the second wireless IC module.

6. An electric kettle of temperature wireless transmission according to the claim 1, wherein a handle is disposed in the body, the wireless transmitter is disposed in the handle.

7. An electric kettle of temperature wireless transmission according to the claim 1, wherein the first wireless IC module and the second wireless IC module are infrared IC module, the wireless receiver is infrared receiver and the wireless transmitter is infrared transmitter.

8. An electric kettle of temperature wireless transmission according to the claim 1, wherein the kettle further includes a probe-type liquid temperature sensor, which is disposed with IC module, thermistor, temperature display and power.

9. An electric kettle of temperature wireless transmission according to the claim 2, wherein the temperature display is the first temperature display disposed in the base, the first temperature display electric connects to the first wireless IC module.

10. An electric kettle of temperature wireless transmission according to the claim 2, wherein the temperature display is the second temperature display disposed in the body, the second temperature display electric connects to the second wireless IC module.

11. An electric kettle of temperature wireless transmission according to the claim 9, wherein a second temperature display is disposed in the body, the second temperature display electric connects to the second wireless IC module.
